(19) United States
(12) Patent Application Publication
(10) Pub. No.: US 2002/0082974 A1
(43) Pub. Date: Jun. 27, 2002

(54) Goods stock market via the internet

(76) Inventor: Viktors Berstis, Austin, TX (US)

Correspondence Address: Duke W. Yee, Carstens, Yee & Cahoon, LLP, P.O. Box 802334, Dallas, TX, 75380, US

(21) Appl. No.: 09/750,978

(22) Filed: Dec. 27, 2000

(51) Int. Cl. G06F 17/60

(52) U.S. Cl. 705/37; 705/26

(57) ABSTRACT

A method, system, and computer program product for matching a buyer and a seller of goods is provided. In one embodiment, an on-line auction or want ad site receives registration information from a registering user. The registration information includes a unique identifier for the item the registering user wishes to buy or sell. The on-line service then identifies a matched user if one exists and notifies the registering user of the match. The unique identifier of the item listed by the matched user exactly matches the unique identifier of the item identified by the registering user. The matched user may be identified by through the use of an on-line auction or reverse auction or may simply be matched based on a search of a database of registered buyers and sellers. The unique identifier allows a buyer to be confident that the item purchased is the item desired.

### BACKGROUND OF THE INVENTION

1. Technical Field

The present invention relates generally to methods of doing business and, more particularly, to methods of matching purchasers with sellers in an on-line auction or for an on-line want ad.

2. Description of Related Art

Lured by the promise of dirt-cheap goods, more and more people are turning to Internet auctions. The number of online auction houses has swelled to more than 150, and the kinds of products now on the block span computer gear to collectibles to sporting goods, and more. Online auctions really can be bargain bonanzas. But only if you do your homework.

Online auction sites are made highly interactive to encourage bidding. They generate automatic bid alerts, send auction schedules to a user's in-box, and deliver a running commentary during the action. Some sites, such as Onsale and First Auction, provide tools to create a personal page that matches your preferences. There are basically two kinds of auctioneers: commercial auction houses and person-to-person auction host sites.

At a commercial auction venue, such as WebAuction or First Auction, buyers compete with one another to buy goods owned by the house that are stocked in clearance warehouses. These items might be unused but aging products, or they may be discontinued, refurbished, used, overstocks, or customer returns.

Most commercial auctioneers require the user to become a member before the user can make a first bid. The user typically must provide current shipping and billing information—including a credit card number. Once registered, the user obtains the site's customization and bidding tools, and user uses a user ID and password to bid. If you the user makes the highest bid, the price of the goods (plus the cost of shipping) is charged to the user's credit card.

At a person-to-person auction site such as eBay or Up4Bid, sellers and bidders meet on middle ground. Sellers pay a fee to list items for sale. After the bidding, the auctioneer notifies the winning bidder and the seller, who make arrangements to complete the transaction privately.

To guard against fraud, person-to-person auction sites take a few precautions. For instance, most sites require sellers to set up an account by supplying billing information (this may include credit card info, email address, and physical address—criteria vary) and sometimes even paying a fee up front. And it's against the rules for sellers to employ multiple email identities; if a site discovers this, the seller's account will be terminated. Credit card information is usually not required from buyers; however, the user must supply a current email address and sometimes other identity-verifying information. Using an anonymous email service such as Yahoo's or Excite's is sometimes allowed, but the auction site may require the user to submit credit card information for verification.

However, although these procedures may help to protect against fraud, the purchaser is often unable to determine whether the items listed for auction specifically match the items that the purchaser desires to purchase. This problem of unambiguously determining the identity and type of item that is listed for sale is not unique to on-line auctions but also is also a problem for internet want ads. For example, a purchaser might wish to purchase a specific PCMCIA Modem, but the information contained on the on-line auction or want ad site does not uniquely identify the item listed for sale although it does specify that the item is a PCMCIA Modem. Therefore, a method, system, and computer program product that allows a seller and a purchaser to be matched up wherein the purchaser is able to unambiguously determine that the item is the correct item would be desirable.

### SUMMARY OF THE INVENTION

The present invention provides a method, system, and computer program product for matching a buyer and a seller of goods. In one embodiment, an on-line auction or want ad site receives registration information from a registering user. The registration information includes a unique identifier for the item the registering user wishes to buy or sell. The on-line service then identifies a matched user if one exists and notifies the registering user of the match. The unique identifier of the item listed by the matched user exactly matches the unique identifier of the item identified by the registering user. The matched user may be identified by through the use of an on-line auction or reverse auction or may simply be matched based on a search of a database of registered buyers and sellers. The unique identifier allows a buyer to be confident that the item purchased is the item desired.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a flowchart illustrating an exemplary process for registering as a buyer or seller of goods or services uniquely identified in accordance with the present invention; and

FIG. 5 depicts a flowchart illustrating an exemplary process for matching a seller and a buyer of goods or services wherein the goods and services are uniquely identified in accordance with the present invention.

### DETAILED DESCRIPTION OF THE PREFERRED EMBODIMENT

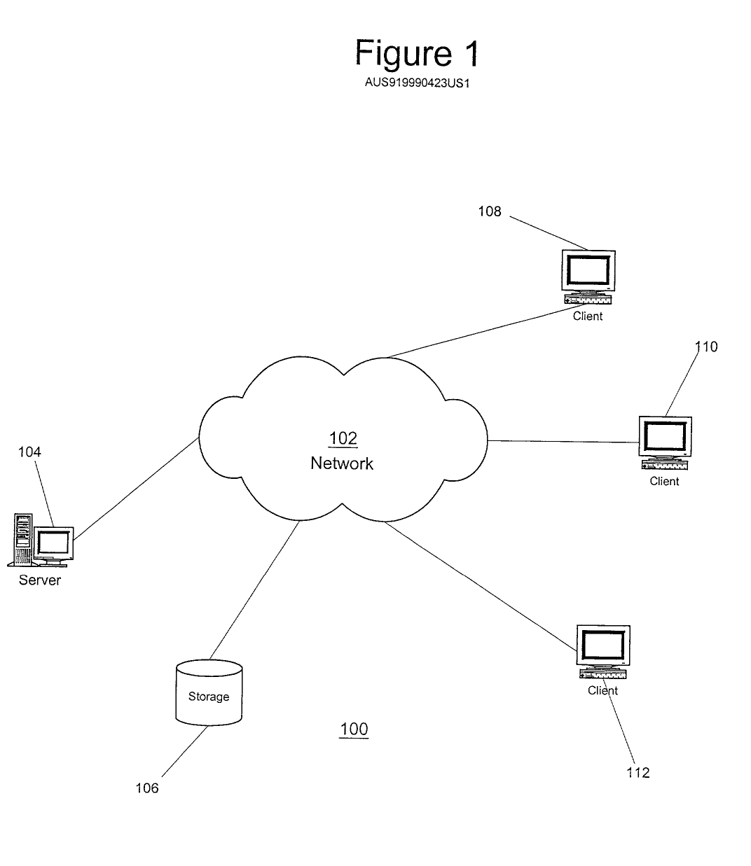

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

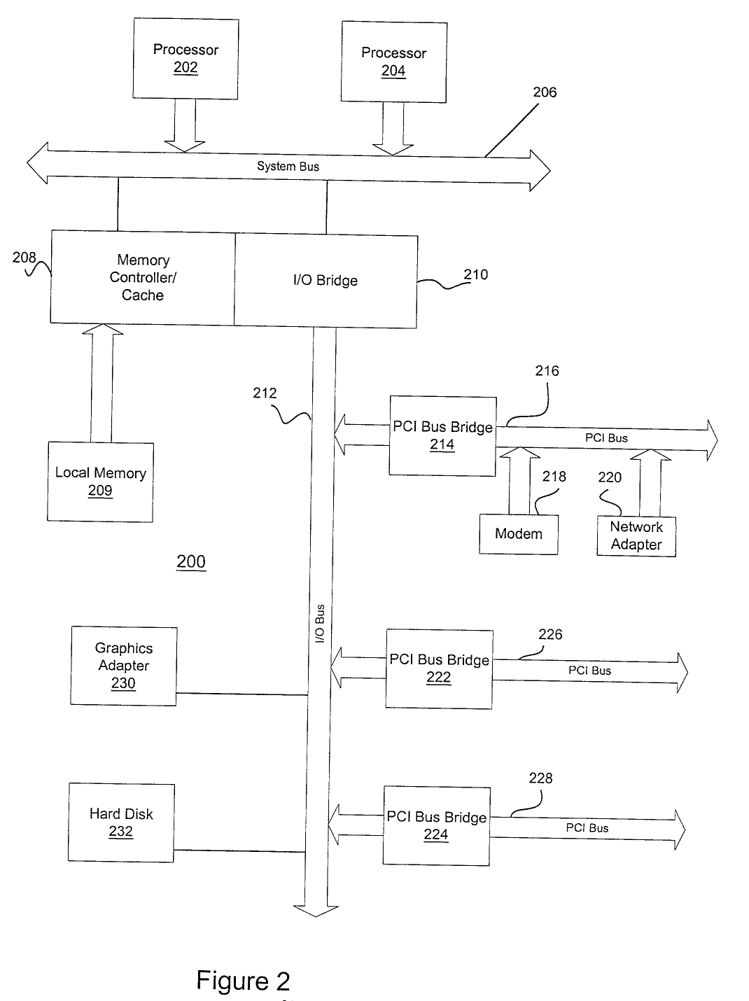

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

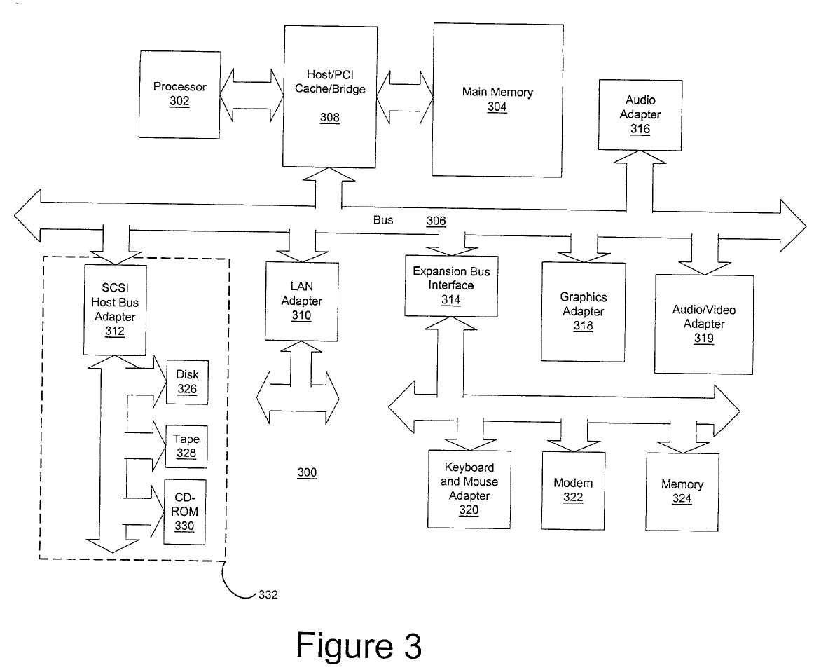

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

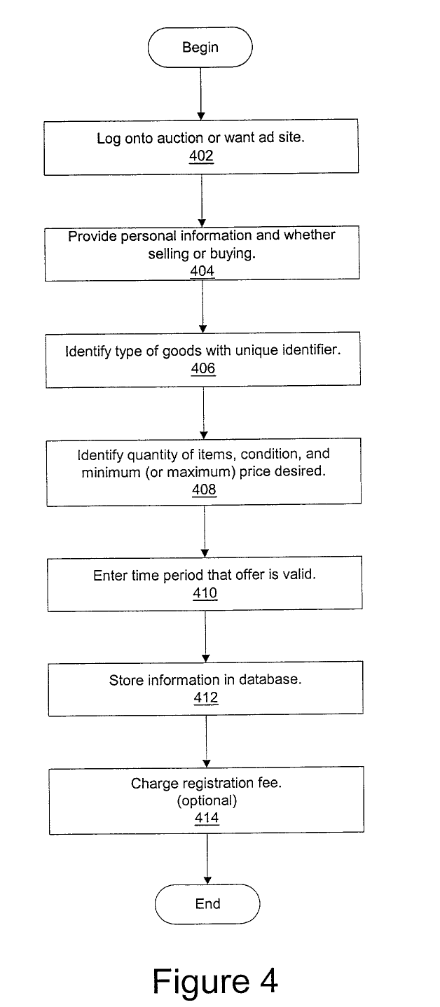

With reference now to FIG. 4, a flowchart illustrating an exemplary process for registering as a buyer or seller of goods or services uniquely identified is depicted in accordance with the present invention. To begin, a seller or buyer logs onto the web site of the on-line auction or want ad (step 402) and provides the site with personal information as well as whether the user is a buyer or seller (step 404). The user may log onto the site using a client, such as client 108 accessing the on-line service, that may be located on a server such as, for example, server 104 via a network, such as network 102 in FIG. 1. The user then supplies the on-line site with the identity of the type of goods including a unique identifier that uniquely distinguishes the goods or services from other goods or services of a similar type (step 406). For example, the unique identifier may be a universal product code (UPC) that uniquely identifies the goods. Thus, a buyer could identify that the buyer desires to buy a particular DVD player from a certain manufacturer with a certain UPC and could be assured that the item for sale is the item the buyer wishes to purchase.

The user then identifies the quantity of the items desired to be sold or bought, the condition of the item to be sold or bought, and the minimum (if the seller) or the maximum (if the buyer) price the user is willing to accept for the goods (step 408). The user then provides the site with the time period for which the offer is valid (step 410). The user could provide conditions that allow the price that is willing to be accepted by the user to change with time. In such manner, if the offer is not accepted within a certain period of time, the acceptable price may be changed to allow for a wider number of potential buyers or sellers, thus allowing the buyer or seller to still buy or sell the desired item although for a larger or smaller price than originally desired.

The on-line site then attempts to match the user with an appropriate buyer or seller previously stored in a database and also stores the new user information in the database (step 412). The database of buyer and seller information may be stored in, for example, storage 106 in FIG. 1. The on-line service may optionally also charge the user a registration fee (step 414). Alternatively, the on-line service may charge only buyers a fee or only sellers a registration fee. In another embodiment, the on-line service may charge no users for registering, but collect a fee only when a buyer and seller are matched.

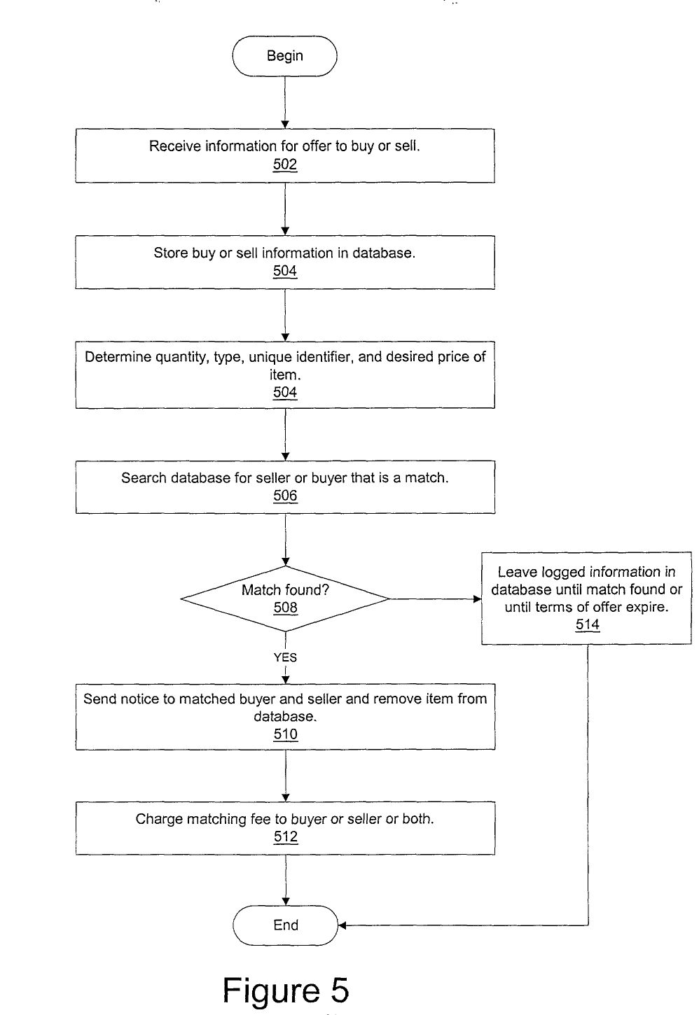

With reference now to FIG. 5, a flowchart illustrating an exemplary process for matching a seller and a buyer of goods or services wherein the goods and services are uniquely identified is depicted in accordance with the present invention. Once an on-line site receives information from a user for an offer to buy or sell a particular good (step 502), the on-line auction or want ad site stores the user's buy or sell information in a database (step 504). The on-line auction or want ad site also determines the quantity, type, unique identifier, and desired price of the item (step 504) and searches the database for a seller or buyer, as the case may be, that is a match (step 506). The match would match a buyer desiring a certain good with a certain unique identifier with a seller selling the same good with the same unique identifier. The on-line site, in determining a match, also determines that the two offers are both valid as determined by time constraints that may have been placed on each offer by the buyer or seller.

To make a match, it may or may not be required that the condition and the quantity of goods for sale exactly match the condition and the quantity of goods sought to be purchased. For example, a seller may have five items for sale, but be willing to sell only one item at a time if a purchaser desiring all five is not found. Furthermore, a buyer may be willing to accept a range of conditions of goods rather than goods in a specific condition. If a range of conditions is acceptable, the purchaser may place different price constraints upon the purchase, such that less is offered for lesser quality goods.

If no match is found between a buyer and a seller for the received offer, then the offer information is left logged in the database until a match is found at a later time or until purged from the database because the terms of the offer have expired (step 514). If a match is found, then the on-line site sends a notice to both the buyer and seller notifying them of the match and modifies or removes the buyer and seller information to reflect the transaction (step 510). The offer information for both the buyer and seller may be modified or removed immediately when the notice is sent to each or the information may be kept, but with a flag indicating a pending transaction until notice is received from the buyer and seller confirming the transaction. If the offer information is immediately modified or removed, if the transaction later fails, the information may be reinstated with notice from the buyer and/or seller. If there is a dispute over the transaction, the buyer and seller may be required to submit to an arbitration procedure and the lower required to execute the sale or purchase of the same product at the price agreed to in the offer after the dispute is resolved. Shipping charges may be split by the buyer and seller or may be paid by only one of the parties to the transaction. The on-line site then may charge a fee for providing a match to either the buyer or seller or both (step 512).

In other embodiments of the present invention, rather than automatically matching a seller and a buyer who have both registered, a seller may register an item including a unique identifier such as in the manner depicted in FIG. 4. Then rather than a buyer registering, a buyer may register personal information for an auction and participate in a bidding process. Thus, the seller states a minimum price for which he is willing to part with the item, but then may receive a higher price for the item as the price of the item is bid up by competing buyers. The buyers, however, may make informed decisions about how much they are willing to pay for the item since a unique identifier is included with the item allowing them to know precisely whether the item is one that they desire.

Alternatively, rather than selling the item at a conventional auction, a reverse auction may be utilized to sell an item. In a reverse auction, the buyer registers personal information, item desired, unique identifier of the item, and perhaps a maximum price willing to pay. Sellers may then log onto the auction and find a buyer who desires an item that they have based upon the unique identifier. The sellers may then make competing offers with the buyer accepting the lowest offer made during the auction period.

Other modifications to the present invention may be made as well as will be recognized by persons skilled in the art. For example, in some instances, such as auctions, it may not be necessary to specify a maximum or minimum price, but rather the buyer or seller may be required to accept the best offer made during the auction time period.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of matching a buyer and a seller of goods; the method comprising:
receiving registration information from a registering user, wherein the registration information includes a unique identifier for an item; and
responsive to identifying a matched user, notifying the user of the match, wherein the unique identifier of the item in the matched user exactly matches the unique identifier of the item identified by the registering user.

2. The method as recited in claim 1, wherein the step of identifying a matched user comprises searching a database for a transactional match, wherein the transactional match contains complementary offer terms to the offer terms of the registering user.

3. The method as recited in claim 1, wherein the registering user is a seller and the step of identifying a matched user comprises conducting an auction at which multiple potential buyers competitively bid against one another with the matched user being the winning potential buyer.

4. The method as recited in claim 3, wherein the winning potential buyer is a potential buyer offering the highest price for the item.

5. The method as recited in claim 1, wherein the registering user is a buyer and the step of identifying a matched user comprises conducting a reverse auction in which a plurality of potential sellers bid to sell the item to the registering user with the matched user being a winning potential seller.

6. The method as recited in claim 5, wherein the winning potential seller is the potential seller offering a lowest selling price for the item.

7. The method as recited in claim 1, wherein the unique identifier is a universal product code.

8. The method as recited in claim 1, wherein the registering user is a buyer and the registration information includes a maximum price willing that the buyer is willing to pay for the item.

9. The method as recited in claim 1, wherein the registration information includes a description of the condition of the item.

10. The method as recited in claim 1, wherein the registering user is a seller and the registration information includes a minimum price that the seller is willing to accept for the item.

11. A computer program product in a computer readable media for use in a data processing system for matching a buyer and a seller of goods; the computer program product comprising:
first instructions for receiving registration information from a registering user, wherein the registration information includes a unique identifier for an item; and
second instructions, responsive to identifying a matched user, for notifying the user of the match, wherein the unique identifier of the item in the matched user exactly matches the unique identifier of the item identified by the registering user.

12. The computer program product as recited in claim 11, wherein the instructions for identifying a matched user comprise searching a database for a transactional match, wherein the transactional match contains complementary offer terms to the offer terms of the registering user.

13. The computer program product as recited in claim 11, wherein the registering user is a seller and the instructions for identifying a matched user comprises conducting an auction at which multiple potential buyers competitively bid against one another with the matched user being the winning potential buyer.

14. The computer program product as recited in claim 13, wherein the winning potential buyer is a potential buyer offering the highest price for the item.

15. The computer program product as recited in claim 11, wherein the registering user is a buyer and the instructions for identifying a matched user comprise conducting a reverse auction in which a plurality of potential sellers bid to sell the item to the registering user with the matched user being a winning potential seller.

16. The computer program product as recited in claim 15, wherein the winning potential seller is the potential seller offering a lowest selling price for the item.

17. The computer program product as recited in claim 11, wherein the unique identifier is a universal product code.

18. The computer program product as recited in claim 11, wherein the registering user is a buyer and the registration information includes a maximum price willing that the buyer is willing to pay for the item.

19. The computer program product as recited in claim 11, wherein the registration information includes a description of the condition of the item.

20. The computer program product as recited in claim 11, wherein the registering user is a seller and the registration information includes a minimum price that the seller is willing to accept for the item.

21. A system for matching a buyer and a seller of goods; the system comprising:
first means for receiving registration information from a registering user, wherein the registration information includes a unique identifier for an item; and
second means, responsive to identifying a matched user, for notifying the user of the match, wherein the unique identifier of the item in the matched user exactly matches the unique identifier of the item identified by the registering user.

22. The system as recited in claim 21, wherein the means for identifying a matched user comprise searching a database for a transactional match, wherein the transactional match contains complementary offer terms to the offer terms of the registering user.

23. The system as recited in claim 21, wherein the registering user is a seller and the means for identifying a matched user comprises conducting an auction at which multiple potential buyers competitively bid against one another with the matched user being the winning potential buyer.

24. The system as recited in claim 23, wherein the winning potential buyer is a potential buyer offering the highest price for the item.

25. The system as recited in claim 21, wherein the registering user is a buyer and the means for identifying a matched user comprise conducting a reverse auction in which a plurality of potential sellers bid to sell the item to the registering user with the matched user being a winning potential seller.

26. The system as recited in claim 25, wherein the winning potential seller is the potential seller offering a lowest selling price for the item.

27. The system as recited in claim 21, wherein the unique identifier is a universal product code.

28. The system as recited in claim 21, wherein the registering user is a buyer and the registration information includes a maximum price willing that the buyer is willing to pay for the item.

29. The system as recited in claim 21, wherein the registration information includes a description of the condition of the item.

30. The system as recited in claim 21, wherein the registering user is a seller and the registration information includes a minimum price that the seller is willing to accept for the item.
